(19) United States
(12) Patent Application Publication
(10) Pub. No.: US 2023/0381902 A1
(43) Pub. Date: Nov. 30, 2023

(54) MECHANICAL STRUCTURAL MEMBER FOR MACHINE TOOL COMBINED BY SECTION STEEL AND STEEL PIPE

(71) Applicants: Shen QIAO, Yangzhou (CN); Jiangsu Yishou Machinery Technology Co., Ltd., Yangzhou (CN)

(72) Inventors: Guozheng HOU, Yangzhou (CN); Shen QIAO, Yangzhou (CN)

(73) Assignees: Shen QIAO, Yangzhou (CN); Jiangsu Yishou Machinery Technology Co., Ltd., Yangzhou (CN)

(21) Appl. No.: 18/450,374

(22) Filed: Aug. 15, 2023

(51) Int. Cl. B23P 15/28

(52) U.S. Cl. CPC B23P 15/28

(57) ABSTRACT

A mechanical structural member for machine tool combined by section steel and steel pipe comprises a structural member body, which is made of a steel pipe and at least one section steel by welding. The invention has following beneficial effects: the mechanical structural member is composed of section steel and steel pipe, component production is achieved by only cutting materials without creating molds. Besides, important abrasion resistance portions can be made of suitable alloy materials, which have advantages of high heat treatment hardness, good quality and low cost. Since the cross-section of the steel pipe is a closed structure, the inertia moment of the member is improved, thereby improving the stiffness of the member. If both ends of the steel pipe are closed and the middle is filled with plastic cements, the damping characteristics of the member are improved, thereby improving the shock resistance of the member.

### TECHNICAL FIELD

The present invention relates to the mechanical technology field, and more particularly to a mechanical structural member for machine tool combined by section steel and steel pipe.

### BACKGROUND

An existing mechanical structural member for machine tool is generally made by iron castings due to its complex shape. Only by creating molds can each component be produced. Since abrasion resistance portions of the iron castings require heat treatments, it is difficult to improve the hardness, the cost of the component is higher, and the production cycle is long.

In view of the above problems, a mechanical structural member for machine tool combined by section steel and steel pipe is provided.

### SUMMARY

In order to solve the above existing problems, the present invention provides a mechanical structural member for machine tool combined by section steel and steel pipe. The present invention is realized by the following technical solutions.

A mechanical structural member for machine tool combined by section steel and steel pipe comprises a structural member body.

The structural member body is made of a steel pipe and at least one section steel by wedding, a cross-section of the steel pipe is a closed structure, and the section steel is located on a top surface or side surface of the steel pipe to form a beam, column or bed of a machine tool.

Furthermore, a connection between the section steel and the steel pipe is made by one of: electric welding, brazing, gluing or riveting.

Furthermore, the steel pipe is a round, square or rectangular pipe.

Furthermore, the section steel can be any shape.

Furthermore, the machine tool is a lathe, milling machine or drilling machine.

The present invention has the beneficial effects as follow: the mechanical structural member for machine tool is made of the section steel and the steel pipe, the component production is achieved by only cutting materials without creating molds. Besides, the important abrasion resistance portions can be made of suitable alloy materials, which have advantages of high heat treatment hardness, good quality and low cost. Since the cross-section of the steel pipe is a closed structure, the inertia moment of the structural member has been improved, thereby improving the stiffness of the structural member. If both ends of the steel pipe are closed and the middle is filled with plastic cements, the damping characteristics of the structural member can be improved, thereby improving the shock resistance of the structural member.

### BRIEF DESCRIPTION OF DRAWINGS

FIG. 1 is a first structural view of a combined bed.

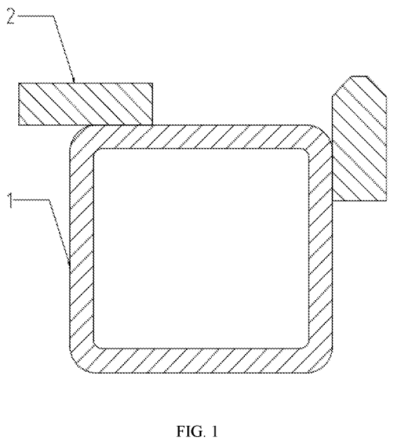

FIG. 2 is a second structural view of the combined bed.

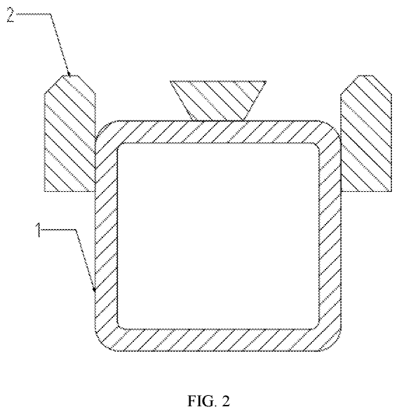

FIG. 3 is a third structural view of the combined bed.

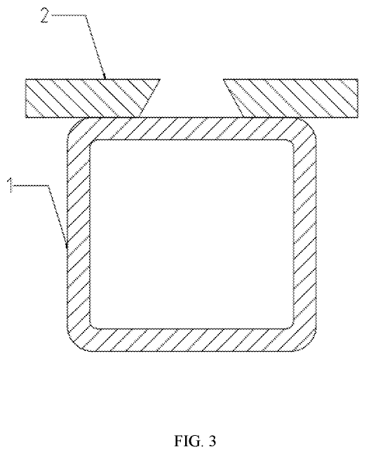

FIG. 4 is a structural view of combined beams.

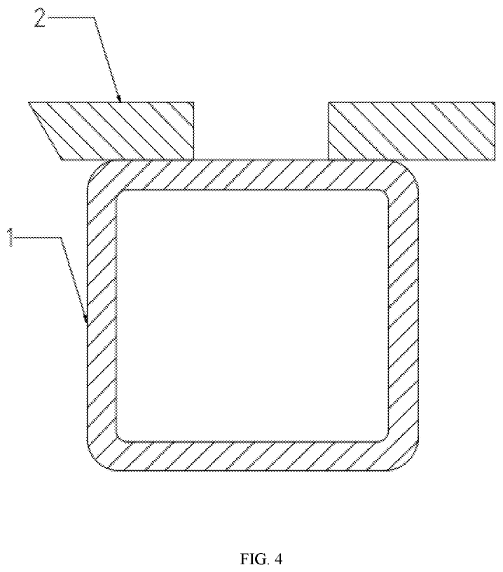

FIG. 5 is a structural view of combined columns.

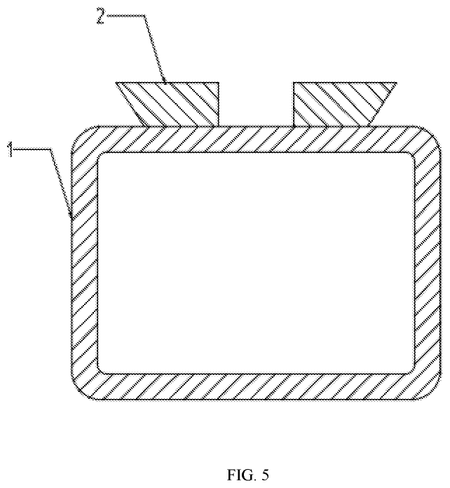

### DETAILED DESCRIPTION OF THE EMBODIMENTS

The technical solutions of present invention will be more clearly and completely illustrated hereafter in combination with the accompanying drawings.

In the descriptions of the present invention, it should be understood that the terms “center”, “longitudinal”, “lateral”, “length”, “width”, “thickness”, “upper”, “lower”, “front”, “back”, “left”, “right”, “vertical”, “horizontal”, “top”, “bottom”, “inside”, “outside”, “clockwise”, “counterclockwise” and so on indicate orientations or positional relationships based on those shown in the accompanying drawings, only for the purposes of facilitating the descriptions of the present invention and simplifying the descriptions, but are not intended to indicate or imply that the device or element referred to must have a particular orientation, be constructed and operated in a particular orientation, and therefore cannot be construed as limitations of the present invention.

Furthermore, the terms “first” and “second” are used only for descriptive purposes and cannot be understood to indicate or imply relative importance or to indicate implicitly the number of technical features indicated. Therefore, the features defined as “first” and “second” features can explicitly or implicitly include at least one of the described features. In the description of the present invention, “plurality” means at least two, such as two, three, unless otherwise specifically defined.

In specific Embodiment 1, a mechanical structural member for machine tool combined by section steel and steel pipe comprises a structural member body.

The structural member body is made of a steel pipe 1 and at least one section steel 2 by welding. A cross-section of the steel pipe 1 is a closed structure, the section steel 2 is located on a top surface or side surface of the steel pipe 1, and the structural member body is made by welding the two section steel 2 on the steel pipe 1. The steel pipe 1 can be a round, square or rectangular pipe, and the section steel 2 can be in any shapes, may be a single or more. The mechanical structural member can be applied into lathes, milling machines or drilling machines as beds, columns or beams.

A connection between the steel pipe 1 and the section steel 2 can be made by one of electric welding, brazing, gluing or riveting.

Connection methods:
riveting and positioning the section steel on the square pipe with a few screws according to design, then welding the square pipe to the section steel firmly, performing high frequency quenching to the portions in demand of the section steel, and completing the mechanical member after subsequent metal processing.

The mechanical structural member for machine tool is composed of the section steels and the steel pipes, the component production is achieved by only cutting materials without creating molds. Besides, the important abrasion resistance portions can be made of suitable alloy materials, which have advantages of high heat treatment hardness, good quality and low cost. Since the cross-section of the steel pipe is a closed structure, the inertia moment of the structural member has been improved, thereby improving the stiffness of the structural member. If both ends of the steel pipe are closed and the middle is filled with plastic cements, the damping characteristics of the structural member can be improved, thereby improving the shock resistance of the structural member.

In the descriptions of the present invention, it should be noted that unless otherwise clearly defined and limited, the terms “arrange”, “connect to”, “connect with” should be understood in a broad sense. For example, it can be fixedly connected, detachably connected, or integrally connected. It can be mechanically connected or electrically connected; it can be directly connected or indirectly connected through an intermediate medium, or it can be the internal communication of two elements. For those skilled in the art, the specific meanings of the above terms in the present invention can be understood in specific circumstances.

In the descriptions of the present invention, unless otherwise expressly provided and defined, a first feature being “on” or “under” a second feature can be interpreted as that the first feature is directly in contact with the second feature, or the first feature is indirectly in contact with the second feature through an intermediate medium. Moreover, the first feature being “above”, “over” and “on” the second feature can be interpreted as that the first feature is directly above or obliquely above the second feature, or can be interpreted simply as that a level height of the first feature is higher than that the second feature. The first feature being “below”, “underneath” and “under” the second feature can be interpreted as that the first feature is directly below or obliquely below the second feature, or can be interpreted simply as that a level height of the first feature is less than that of the second feature.

In the description of the present specification, the reference terms “one embodiment”, “some embodiments”, “examples”, “specific examples”, or “some examples” mean that the specific features, structures, materials or characteristics described in conjunction with the embodiments or examples are included in at least one embodiments or examples of the present invention. In the present specification, indicative expressions of the above terms do not necessarily refer to the same embodiments or examples. Furthermore, the specific features, structures, materials, or characteristics described can be combined in an appropriate manner in any one or more embodiments or examples.

The above described are only some preferred embodiments of the present invention, and they are not used to limit the present invention. Any modifications, equivalent replacements and improvements made within the spirits and principles of the present invention, should be all included in the protection scope of the present invention.

What is claimed is:

1. A mechanical structural member for machine tool combined by section steel and steel pipe, comprising a structural member body, wherein the structural member body is made of a steel pipe and at least one section steel by wedding, a cross-section of the steel pipe is a closed structure, and the section steel is located on a top surface or side surface of the steel pipe to form a beam, column or bed of a machine tool.

2. The mechanical structural member for machine tool combined by section steel and steel pipe according to claim 1, wherein a connection between the section steel and the steel pipe is made by one of electric welding, brazing, gluing or riveting.

3. The mechanical structural member for machine tool combined by section steel and steel pipe according to claim 1, wherein the steel pipe is a round, square or rectangular pipe.

4. The mechanical structural member for machine tool combined by section steel and steel pipe according to claim 1, wherein the section steel can be in any shape.

5. The mechanical structural member for machine tool combined by section steel and steel pipe according to the claim 1, wherein the machine tool is a lathe, milling machine or drilling machine.
